(19) United States
(12) Patent Application Publication
(10) Pub. No.: US 2025/0378097 A1
(43) Pub. Date: Dec. 11, 2025

(54) INFORMATION RETRIEVAL SYSTEM

(71) Applicant: KYOCERA Document Solutions Inc., Osaka (JP)

(72) Inventor: Kunihiko Tanaka, Osaka (JP)

(21) Appl. No.: 19/229,207

(22) Filed: Jun. 5, 2025

(30) Foreign Application Priority Data
Jun. 10, 2024 (JP) 2024-093485

(51) Int. Cl. G06F 16/334; G06F 16/3329

(52) U.S. Cl. CPC G06F 16/3344; G06F 16/3347; G06F 16/33295

(57) ABSTRACT

A context information retrieving unit retrieves a document database with a characteristic vector of a question and thereby acquires as context information a text that a similarity level between the characteristic vector and a characteristic vector of the text satisfies a predetermined condition. A first prompt generating unit generates a first prompt that includes the question and the context information. An answer acquiring unit acquires as a first answer an answer corresponding to the first prompt using a large language model. A second prompt generating unit generates a second prompt that includes the context information and the first answer and causes to provide a confidence of the first answer. An answer verifying unit acquires as a second answer an answer corresponding to the second prompt using a large language model, and determines the confidence with the second answer.

### CROSS-REFERENCE TO RELATED APPLICATIONS

This application relates to and claims priority rights from Japanese Patent Application No. 2024-093485, filed on June 10th, 2024, the entire disclosures of which are hereby incorporated by reference herein.

### BACKGROUND

### FIELD OF THE PRESENT DISCLOSURE

The present disclosure relates to an information retrieval system.

### DESCRIPTION OF THE RELATED ART

Recently, large language models (LLMs) such as GPT of OpenAI and PaLM2 of Google have been put into practical use, and such LLMs are enabled to process a task such as question and answer session in a natural language.

A text generating apparatus (a) generates another question text corresponding to an inputted question text on the basis of question generation examples and a conversation history, (b) calculates a characteristic vector of a text generated from the original question text and the generated other question text, (c) acquires a text having a high similarity from a database on the basis of the characteristic vector, and (d) adds as reference information to the original question text an additional text generated from the acquired text and thereby generates a prompt to be inputted to a LLM.

However, the aforementioned LLMs have a problem "hallucination", and an improper answer (untrue answer, answer based on a fictional fact, or the like) may be generated. Some users may believe that such improper answer is a proper answer.

### SUMMARY

An information retrieval system according to an aspect of the present disclosure is an information retrieval system that provides an answer corresponding to a question using a large language model, and includes a question receiving unit, a context information retrieving unit, a first prompt generating unit, an answer acquiring unit, a second prompt generating unit, and an answer verifying unit. The question receiving unit is configured to receive the question. The context information retrieving unit is configured to retrieve a document database with a characteristic vector of the question and thereby acquire as context information a text that a similarity level between the characteristic vector and a characteristic vector of the text satisfies a predetermined condition. The first prompt generating unit is configured to generate a first prompt that includes the question and the context information. The answer acquiring unit is configured to acquire as a first answer an answer corresponding to the first prompt using a large language model. The second prompt generating unit is configured to generate a second prompt that includes the context information and the first answer and cause to provide a confidence of the first answer. The answer verifying unit is configured to acquire as a second answer an answer corresponding to the second prompt using a large language model, and determine the confidence with the second answer.

These and other objects, features and advantages of the present disclosure will become more apparent upon reading of the following detailed description along with the accompanied drawings.

### BRIEF DESCRIPTION OF THE DRAWINGS

FIG. 1 shows a block diagram that indicates a configuration of an information retrieval system according to an embodiment of the present disclosure;

FIG. 2 shows a diagram that indicates an example of a template for a first prompt;

FIG. 3 shows a diagram that indicates an example of a template for a second prompt;

FIG. 4 shows a diagram that indicates an example of generation of the first prompt;

FIG. 5 shows a diagram that indicates an example of generation of the second prompt; and

FIG. 6 shows a flowchart that explains a behavior of the information retrieval system shown in FIG. 1.

### DETAILED DESCRIPTION

Hereinafter, an embodiment according to an aspect of the present disclosure will be explained with reference to drawings.

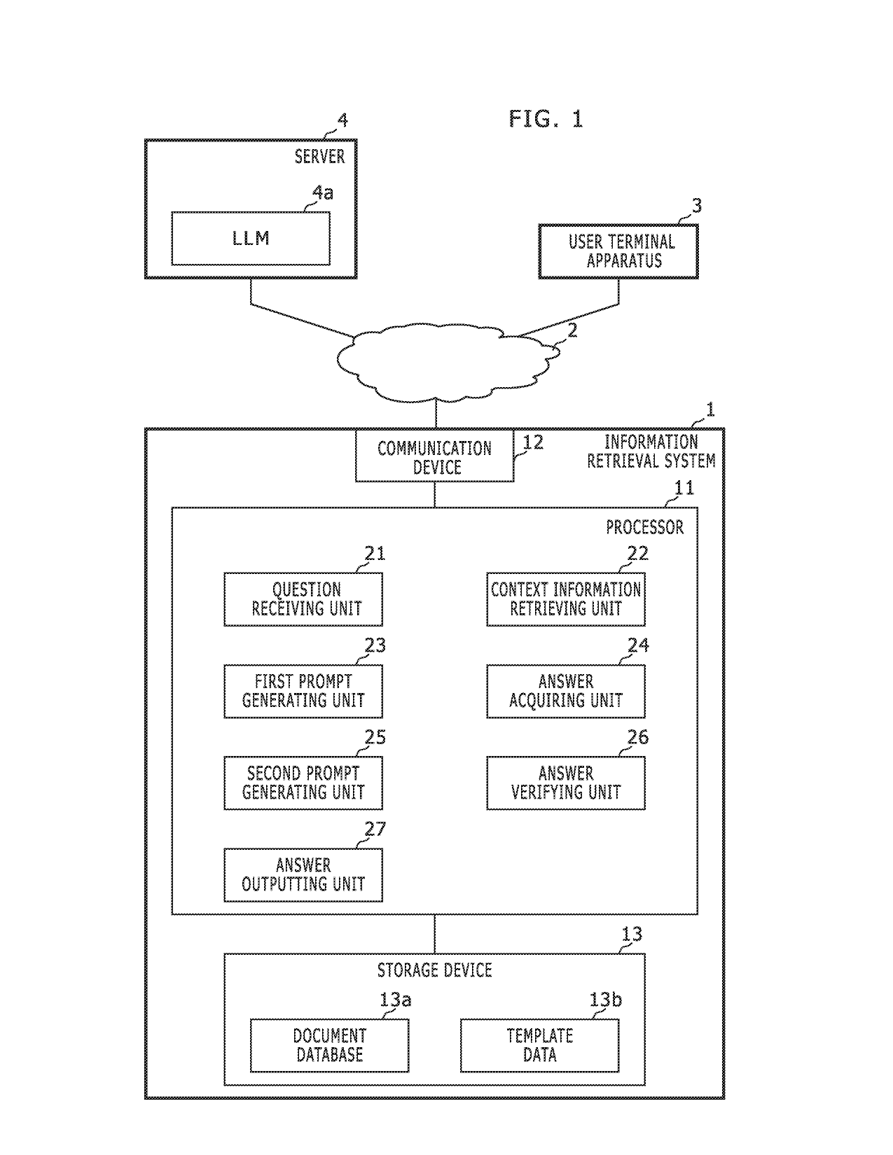

FIG. 1 shows a block diagram that indicates a configuration of an information retrieval system according to an embodiment of the present disclosure. The information retrieval system 1 shown in FIG. 1 is an information retrieval system that provides an answer corresponding to a question using a large language model 4a, and includes a processor 11 as a computer, a communication device 12, and a storage device 13. Here, the information retrieval system 1 is installed in a single computer device, and alternatively, may be dispersedly installed in plural computer devices.

The communication device 12 is a device (network interface or the like) capable of data communication with another device (here the user terminal apparatus 3, the server 4 and the like) through the computer network 2 such as Internet or intranet. The user terminal apparatus 3 is a device capable of network communication, that a user operates, such as personal computer or smart phone. The server 4 includes the large language model 4a, receives a prompt, and upon receiving the prompt, generates an answer corresponding to the prompt using the large language model 4a, and transmits the answer as a response to the prompt.

The storage device 13 is a nonvolatile storage device such as flash memory or hard disk and stores a program and data. In the storage device 13, a document database 13a and template data 13b mentioned below have been stored.

Here, the processor 11 executes a program stored in the storage device 13, and thereby acts as a question receiving unit 21, a context information retrieving unit 22, a first prompt generating unit 23, an answer acquiring unit 24, a second prompt generating unit 25, an answer verifying unit 26, and an answer outputting unit 27.

The question receiving unit 21 receives a question. Specifically, the question receiving unit 21 receives a question text (text data) transmitted from the user terminal apparatus 3 using the communication device 12.

The context information retrieving unit 22 (a) derives a characteristic vector of the received question, and (b) retrieves the document database 13a with the characteristic vector and thereby acquires as context information a text (text data) that a similarity level between the characteristic vector and a characteristic vector of the text satisfies a predetermined condition. Such a characteristic vector is generated from a text (e.g. the question) using an existing embedding process.

The document database 13a stores document text data and a character vector of it so as to associate the document text data and the character vector with each other for each of plural document texts. The document text may be a specific document text in an organization such as company rules, or may be a publicly-available document text.

The first prompt generating unit 23 generates a first prompt that includes the aforementioned question and the aforementioned context information. Specifically, the first prompt generating unit 23 (a) refers to the template data 13b and thereby acquires a template (text data) for the first prompt, and (b) inserts the aforementioned question and the aforementioned context information to the template and thereby generates the first prompt.

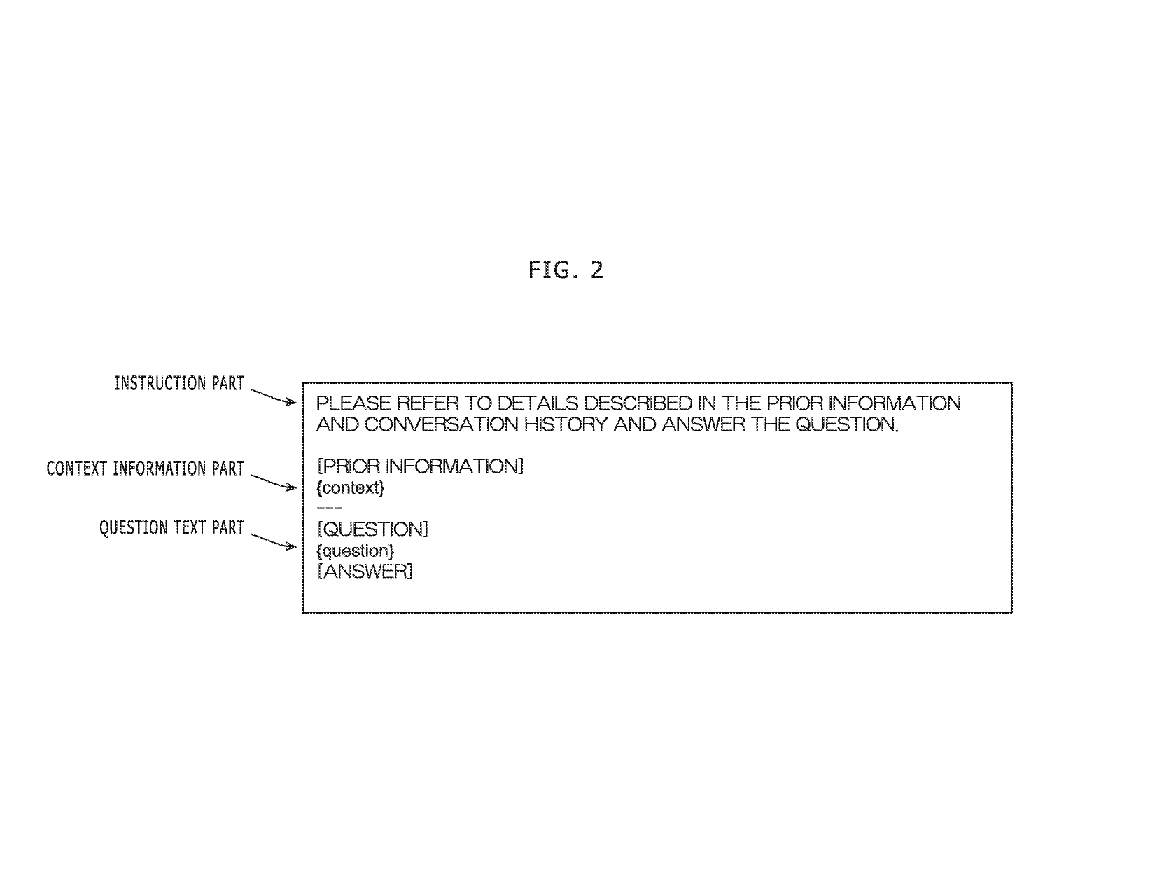

FIG. 2 shows a diagram that indicates an example of a template for a first prompt. The first prompt includes an instruction part, a context information part, and a question text part. The instruction part is a text that indicates an instruction to the large language model 4a, the context information part is a part in which the aforementioned context information is described, and in the template, the context information part includes a parameter {context} to be replaced with the context information. The question text part is a part in which the aforementioned question is described, and in the template, the question text part includes a parameter {question} to be replaced with the question.

The answer acquiring unit 24 acquires as a first answer an answer corresponding to the first prompt using the large language model 4a. Specifically, using the communication device 12, the answer acquiring unit 24 transmits the first prompt to the server 4 of the large language model 4a, and receives an answer corresponding to the first prompt from the server 4.

The second prompt generating unit 25 generates a second prompt that includes the context information and the first answer and causes to provide a confidence of the first answer. Specifically, the second prompt generating unit 25 (a) refers to the template data 13b and thereby acquires a template (text data) for the second prompt, and (b) inserts the aforementioned context information and the aforementioned first answer to the template and thereby generates the second prompt.

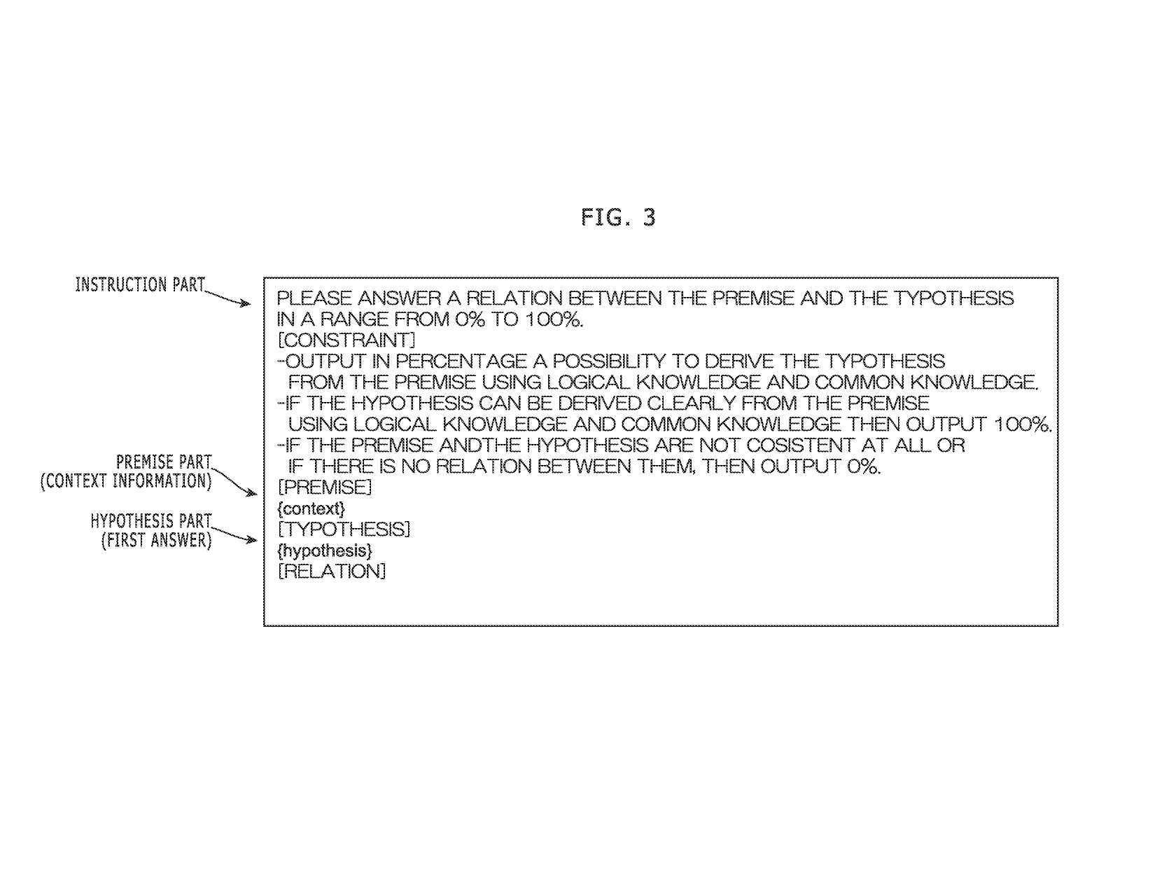

FIG. 3 shows a diagram that indicates an example of a template for a second prompt. The second prompt includes an instruction part, a premise part in which the context information is described, and a hypothesis part in which the first answer is described. The instruction part is a text that indicates an instruction to the large language model 4a. In the template, the premise part includes a parameter {context} to be replaced with the context information, and the hypothesis part includes a parameter {hypothesis} to be replaced with the first answer.

The answer verifying unit 26 acquires as a second answer an answer corresponding to the second prompt using the large language model 4a, and determines a confidence of the first answer with the second answer. Here, the large language model 4a is instructed such that this confidence is expressed as a confidence level that is a normalized numeral value (continuous value or discrete value), as shown in FIG. 3, for example. The large language model 4a may be instructed such that this confidence is expressed with a natural language such as "good" or "not good".

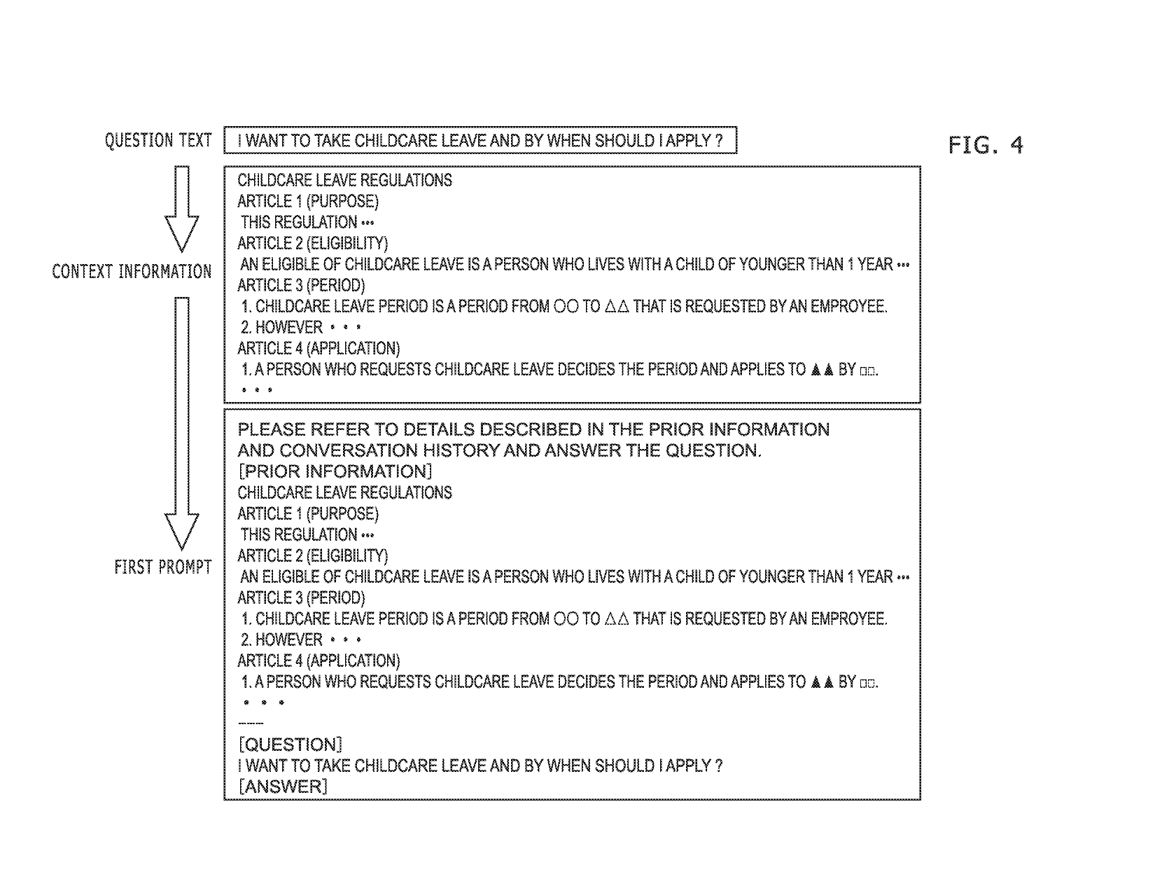

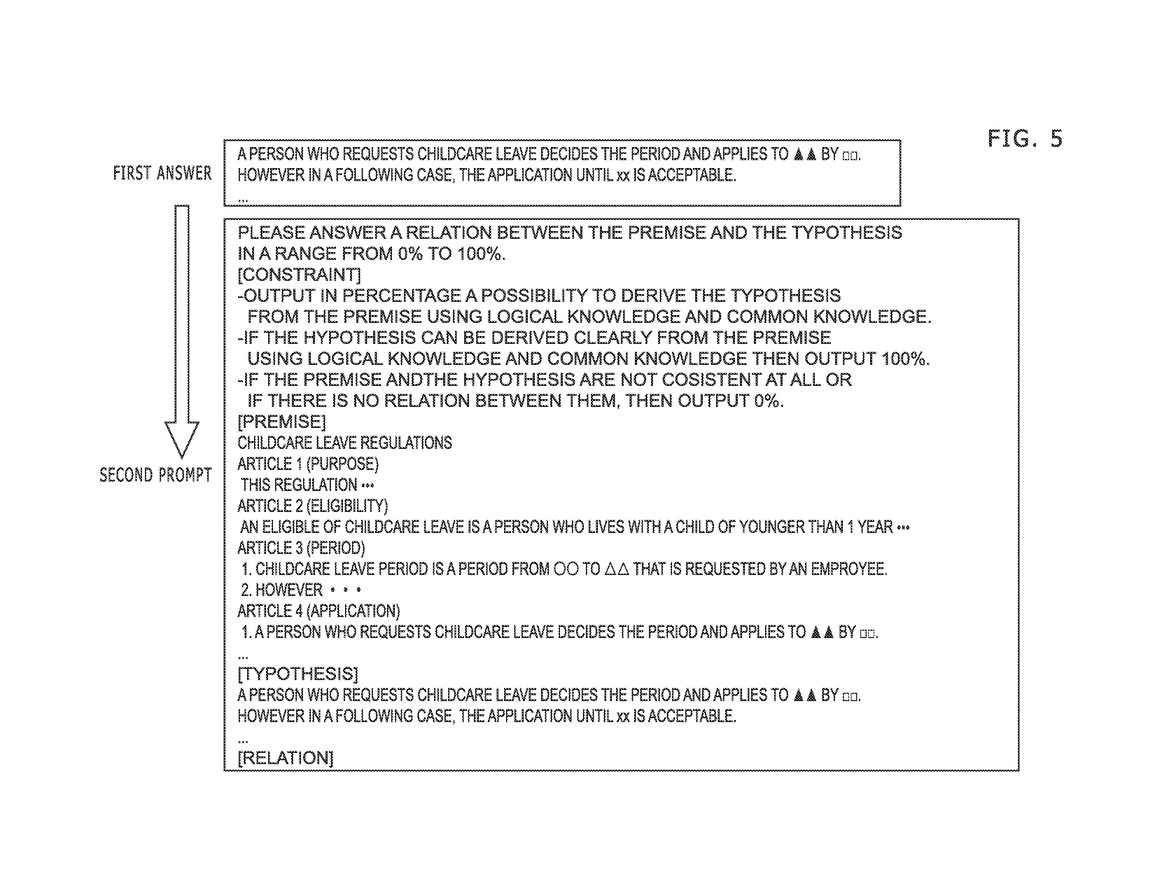

FIG. 4 shows a diagram that indicates an example of generation of the first prompt. FIG. 5 shows a diagram that indicates an example of generation of the second prompt. For example, the document database 13a includes a document of a company rule such as employment regulation, if a question related to childcare leave as shown in FIG. 4, for example is received, then a text of a childcare leave regulation is detected as context information from the document database 13a, and in the template of the first prompt, the aforementioned parameters are replaced with the question and the context information, and thereby the first prompt is generated as shown in FIG. 4, for example. Further, as shown in FIG. 5, for example, if the first answer corresponding to the first prompt shown in FIG. 4 is acquired from the large language model 4a, then in the template of the second prompt, the aforementioned parameters are replaced with the first answer and the context information, and thereby the second prompt is generated as shown in FIG. 5, for example.

Returning to FIG. 1, the answer outputting unit 27 determines whether an answer that includes the first answer and the confidence (specifically, a text that indicates the confidence) should be outputted as an answer of the question or not on the basis of the aforementioned confidence. If an answer that includes the first answer and the confidence should be outputted as an answer of the question, then the answer outputting unit 27 outputs an answer that includes the first answer and the confidence as an answer of the question. Contrarily, if an answer that includes the first answer and the confidence should not be outputted as an answer of the question, then the answer outputting unit 27 does not output an answer that includes the first answer as an answer of the question.

If it is determined that an answer that includes the first answer and the confidence should not be outputted as an answer to the question, then the answer outputting unit 27 outputs an answer that includes a warning message as an answer to the question. In this case, the answer outputting unit 27 may output an answer that includes the warning message and the context information as an answer to the question. For example, the warning message indicates that a high-confidence answer was not acquired. Further, the warning message may include a message for a user to prompt to refer to the context information or may include a message for a user to prompt to refer to a material (e.g. company rules) related to the context information or the question.

It should be noted that the aforementioned answer of the question is transmitted by the answer outputting unit 27 using the communication device 12 to the user terminal apparatus 3, and displayed to a user by the user terminal apparatus 3.

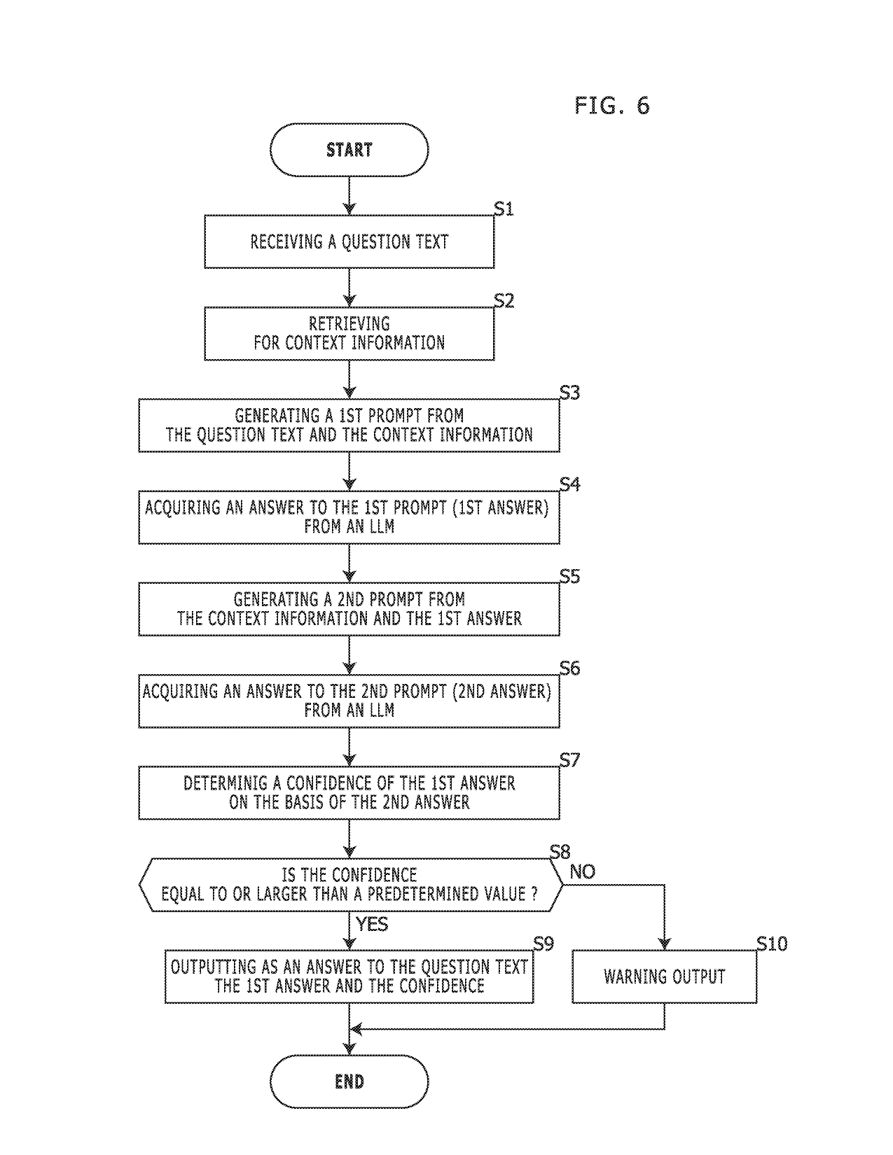

The following part explains a behavior of the aforementioned information retrieval system. FIG. 6 shows a flowchart that explains a behavior of the information retrieval system shown in FIG. 1.

When the question receiving unit 21 receives a question (in Step S1), the context information retrieving unit 22 derives a characteristic vector of the question, and retrieves the document database 13a with the characteristic vector and thereby acquires context information (in Step S2).

Subsequently, the first prompt generating unit 23 generates a first prompt that includes the aforementioned question and the aforementioned context information (in Step S3), and the answer acquiring unit 24 acquires as a first answer an answer corresponding to the first prompt using the large language model 4a (in Step S4).

Subsequently, the second prompt generating unit 25 generates a second prompt that includes the context information and the first answer (in Step S5), and the answer verifying unit 26 acquires as a second answer an answer corresponding to the second prompt using the large language model 4a (in Step S6), and determines a confidence of the first answer (here, confidence level as numerical value) from the second answer (in Step S7).

The answer outputting unit 27 determines whether an answer that includes the first answer and the confidence of it should be outputted as an answer of the question or not on the basis of the aforementioned confidence (in Step S8). Specifically, the answer outputting unit 27 determines whether the confidence is equal to or larger than a predetermined threshold value or not.

If the confidence is equal to or larger than a predetermined threshold value, then the confidence of the first answer is high and therefore the answer outputting unit 27 outputs as an answer of the question an answer that includes the first answer and the confidence (in Step S9).

Contrarily, if the confidence is less than the predetermined threshold value, then the confidence of the first answer is low and therefore the answer outputting unit 27 does not output as an answer of the question an answer that includes the first answer and the confidence but outputs the aforementioned warning message or the like as an answer of the question (in Step S10).

As mentioned, in the aforementioned embodiment, the context information retrieving unit 22 retrieves the document database 13a with a characteristic vector of a question and thereby acquire as context information a text that a similarity level between the characteristic vector and a characteristic vector of the text satisfies a predetermined condition. The first prompt generating unit 23 generates a first prompt that includes the question and the context information, and the answer acquiring unit 24 acquires as a first answer an answer corresponding to the first prompt using the large language model 4a. The second prompt generating unit 25 generates a second prompt that includes the context information and the first answer and causes to provide a confidence of the first answer, and the answer verifying unit 26 acquires as a second answer an answer corresponding to the second prompt using the large language model 4a, and determines a confidence of the first answer from the second answer.

Consequently, a response to a user's question is provided correspondingly to a confidence of an answer acquired from a large language model to the question, and therefore it is restrained that a user believes an improper answer.

It should be understood that various changes and modifications to the embodiments described herein will be apparent to those skilled in the art. Such changes and modifications may be made without departing from the spirit and scope of the present subject matter and without diminishing its intended advantages. It is therefore intended that such changes and modifications be covered by the appended claims.

For example, in the aforementioned embodiment, the answer verifying unit 26 acquires an answer corresponding to the second prompt using the large language model 4a that is used for an answer corresponding to the first prompt, and alternatively, the answer verifying unit 26 may acquire an answer corresponding to the second prompt using another large language model than the large language model 4a.

What is claimed is:

1. An information retrieval system that provides an answer corresponding to a question using a large language model, comprising:
a question receiving unit configured to receive the question; a context information retrieving unit configured to retrieve a document database with a characteristic vector of the question and thereby acquire as context information a text that a similarity level between the characteristic vector and a characteristic vector of the text satisfies a predetermined condition;
a first prompt generating unit configured to generate a first prompt that includes the question and the context information;
an answer acquiring unit configured to acquire as a first answer an answer corresponding to the first prompt using a large language model;
a second prompt generating unit configured to generate a second prompt that includes the context information and the first answer and cause to provide a confidence of the first answer; and
an answer verifying unit configured to acquire as a second answer an answer corresponding to the second prompt using a large language model, and determine the confidence with the second answer.

2. The information retrieval system according to claim 1, further comprising an answer outputting unit configured (a) to determine whether an answer that includes the first answer and the confidence should be outputted as an answer to the question or not on the basis of the confidence, (b) if it is determined that an answer that includes the first answer and the confidence should be outputted as an answer to the question, to output an answer that includes the first answer and the confidence, and if it is determined that an answer that includes the first answer and the confidence should not be outputted as an answer to the question, not to output an answer that includes the first answer.

3. The information retrieval system according to claim 2, wherein if it is determined that an answer that includes the first answer and the confidence should not be outputted as an answer to the question, the answer outputting unit outputs an answer that includes a warning message as an answer to the question.

4. The information retrieval system according to claim 3, wherein if it is determined that an answer that includes the first answer and the confidence should not be outputted as an answer to the question, the answer outputting unit outputs an answer that includes the warning message and the context information as an answer to the question.

5. The information retrieval system according to claim 1, wherein the confidence is expressed as a confidence level that is a normalized numeral value.
